(19) United States
(12) Patent Application Publication
(10) Pub. No.: US 2021/0326423 A1
(43) Pub. Date: Oct. 21, 2021

(54) SYSTEM AND METHOD FOR ONLINE VERIFICATION OF THE IDENTITY OF A SUBJECT

(71) Applicant: INVENTIA S.R.L., Milano (IT)

(72) Inventors: Andrea CINELLI, Milano (IT); Antonio MINOSI, Milano (IT)

(21) Appl. No.: 17/255,535

(22) PCT Filed: Jun. 27, 2019
(86) PCT No.: PCT/IB2019/055439

§ 371 Date: Dec. 23, 2020

(30) Foreign Application Priority Data
Jun. 28, 2018 (IT) 102018000006758

(51) Int. Cl. G06F 21/32; H04L 29/06; G06K 9/00

(52) U.S. Cl. CPC G06F 21/32; H04L 63/0861; G06K 9/00288; H04L 63/0838; G06K 9/00255; G06K 9/00315; G06K 9/00248

(57) ABSTRACT

It is disclosed an electronic system for online verification of the identity of a subject including a user electronic device, a network element and a non-volatile memory. The memory is configured to store data representative of a reference biometric profile of the subject. The user electronic device comprises a camera configured to acquire an image representative of a portion of the body of a subject, and comprises a processing unit configured to generate a sample biometric profile, as a function of at least one image acquired in real time representative of at least one portion of the body of the subject. The system uses a strong authentication based on the combination of two factors, wherein the first factor is a biometric recognition of the subject to be identified and the second factor is the use of an access code valid only once for a defined time interval.

### BACKGROUND

### Technical Field

The present disclosure generally relates to the field of verification of the identity of a subject.

More particularly, the present disclosure concerns a system and method for online verification of the identity of a subject, such as a user of a mobile electronic device or of a personal computer.

### Description of the Related Art

The authentication procedure is well known wherein the identity of a subject who has been identified in a previous identification step is verified online: in the authentication step it is verified in real time that the subject (for example, a user of a smartphone or a personal computer) who wants to use a particular service is actually the subject he/she has claimed to be in the previous identification step.

For example, the service can be the access to a bank account, the subscription of a long-distance contract, or the opening of a bank account.

In the authentication procedure it is known to perform said identify verification by means of the use of a random code valid only for a single session for a defined time period, indicated with “One-Time Password” or “One-Time PIN” (abbreviated OTP), which is composed of an alphanumeric string.

The OTP code is used for example when a subject wants to access a service by means of a personal computer or a mobile electronic device, such as a smartphone or tablet.

The OTP code can be generated by means of a dedicated device (token) that was previously delivered to the subject to be identified.

Alternatively, the OTP code is generated by the supplier of the authorised service and is sent by means of a short text message (SMS) to the users smartphone, who then enters the value of the OTP code in an appropriate field of a web page displayed on the screen of the personal computer or in a field of a screen displayed on the screen of the user's same smartphone by means of a suitable application.

International patent application PCT/IB2018/052282 in the name of the same Applicant discloses a system and method for the online verification of a subject by a remote operator, by means of a real-time image of the subject shown to the remote operator together with an image representative of the text message containing the OTP code using only a mobile electronic device such as a smartphone.

The use of strong authentication procedures is known using the combination of at least two factors of a different type to increase the level of security with which the subject is identified, in particular by using a factor known to the subject to be identified (for example, a password) and a factor associated with a physical object belonging to the user.

Italian patent application no. 102017000145528 filed on 18 Dec. 2017 in the name of the same Applicant discloses a biometric recognition of a live face of a subject, using a plurality of biometric parameters of the face of the subject calculated by means of a movement of his/her head.

The Applicant has observed that a disadvantage of the known techniques of online verification of the identity of a subject is that they do not guarantee with sufficient certainty that the subject to be identified is actually who he/she claims to be.

For example, in the case wherein an OTP code is used:

if the OTP code is generated by means of a dedicated token device previously delivered by the service provider to the subject to be identified, the dedicated device could have been stolen by third parties;

if the OTP code is transmitted to the smartphone of the subject to be identified by means of a short text message, the smartphone could be temporarily used by another person other than the subject to be identified or could have been stolen.

US patent application having publication number US 2003/163739 A1 discloses an authentication system that uses two authentication factors, wherein the first factor is biometric in the form of voice or fingerprints, while the second factor is an access code (for example, an OTP).

### BRIEF SUMMARY

The present disclosure relates to an online system for verifying the identity of a subject as defined in enclosed claim 1 and its preferred embodiments thereof described in the dependent claims from 2 to 9.

The Applicant has perceived that the online system for verifying the identity of the subject according to the present disclosure can increase the security level of the identification of the subject.

The basic idea is to use a strong authentication based on the combination of at least two factors of a different type, wherein a first factor is a biometric recognition of the subject to be identified (in particular, facial biometric recognition), while the second factor is the use of an access code valid only once (OTP) for a defined time interval (for example transmitted by means of a text message).

It is also an object of the present disclosure an online verification method for verifying the identity of a subject, wherein the method is defined in the enclosed claim 10 and in the preferred embodiments described in the dependent claims 11-13.

It is also an object of the present disclosure a non-transitory computer readable medium as defined in the enclosed claim 15.

### BRIEF DESCRIPTION OF THE DRAWINGS

Additional features and advantages of the disclosure will become more apparent from the description which follows of a preferred embodiment and the variants thereof, provided by way of example with reference to the appended drawings, in which:

FIG. 1 shows a block diagram of system for online verification of the identity of a subject according to the disclosure;

FIG. 2 shows more in detail the block diagram of a user electronic device inside the verification system of FIG. 1;

FIGS. 3A-3C show the flow chart of the method for online identification and authentication of a subject according to the disclosure;

FIGS. 4A-4C show the time diagram of the method for online identification and authentication of a subject according to the disclosure in a case of positive and negative outcome of the online verification of the identity of the subject;

FIGS. 5A-5B show the screenshots displayed on the screen of the user electronic device of the mobile type during the online verification procedure of the digital identity of the subject.

### DETAILED DESCRIPTION

It should be observed that in the following description, identical or analogous blocks, components or modules are indicated in the figures with the same numerical references, even where they are illustrated in different embodiments of the disclosure.

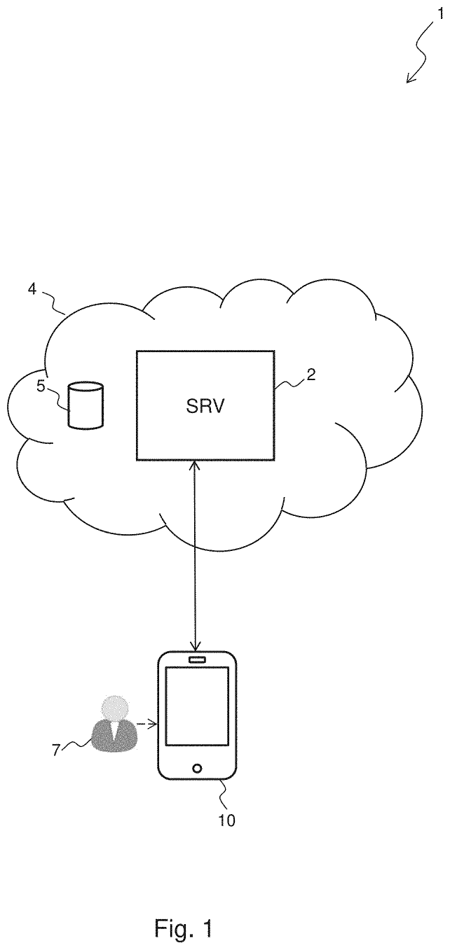

With reference to FIG. 1, it shows a block diagram of an electronic system 1 for the online verification (i.e. in real time) of the identity of a subject 7 according to one embodiment of the disclosure.

The electronic system 1 comprises:

a user electronic device 10 controlled by a subject 7 (indicated hereinafter also with “user” 7);

a network element 2.

In one embodiment, the electronic system 1 comprises a further network element (for example a network server) having the function of validating the access to the service requested by the subject 7 (for example, a bank operation on his/her online bank account).

The network element 2 is part of a telecommunications network 4 that comprises a plurality of network elements interposed between the user electronic device 10 and the network element 2.

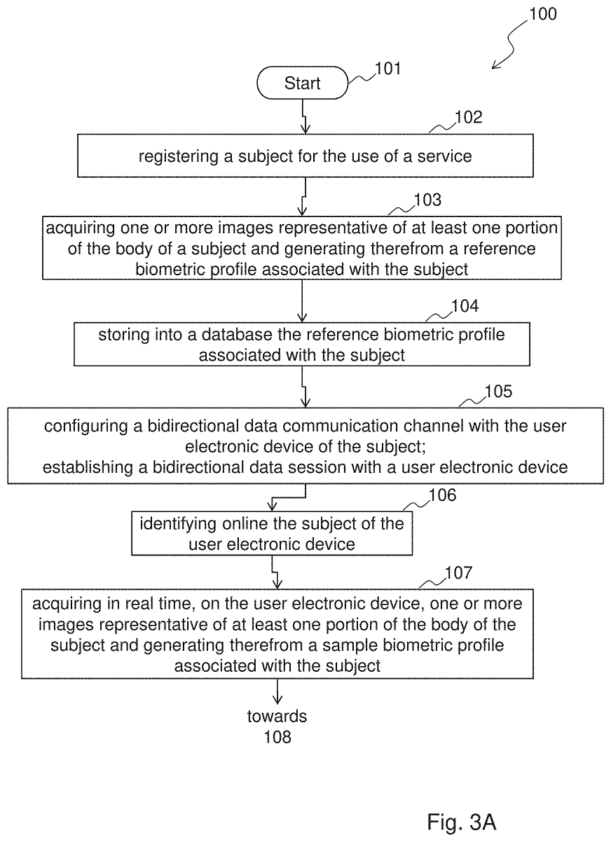

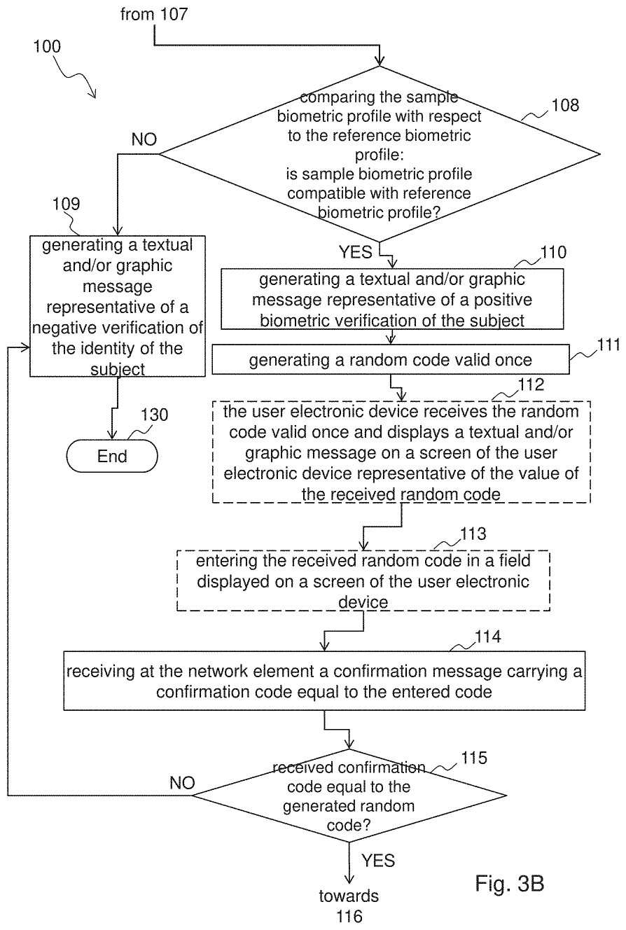

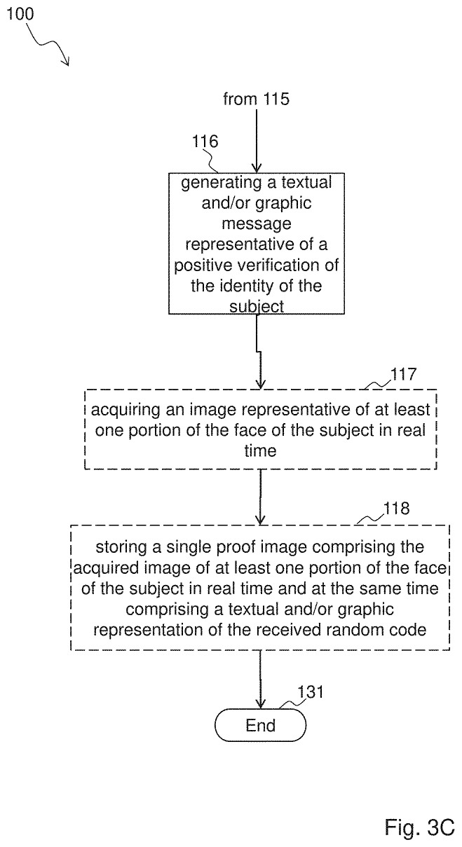

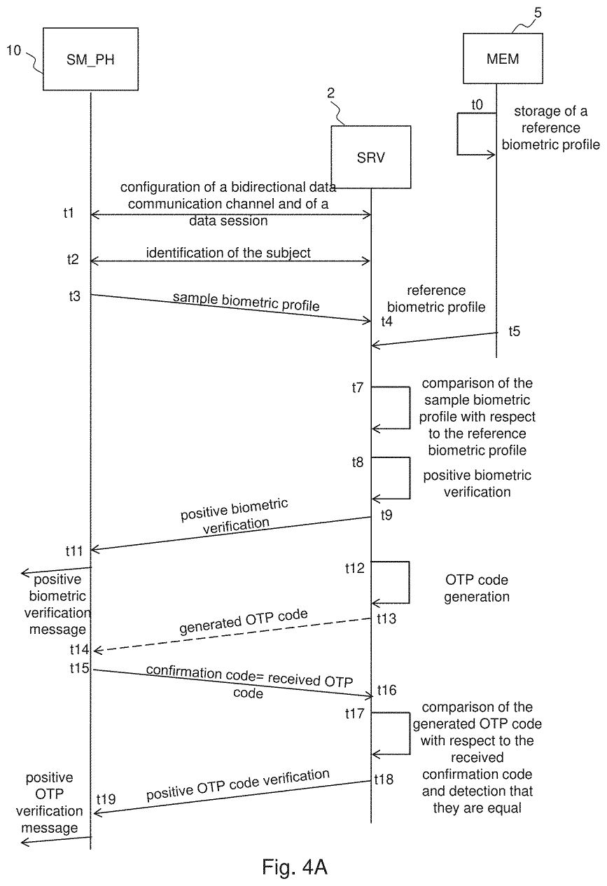

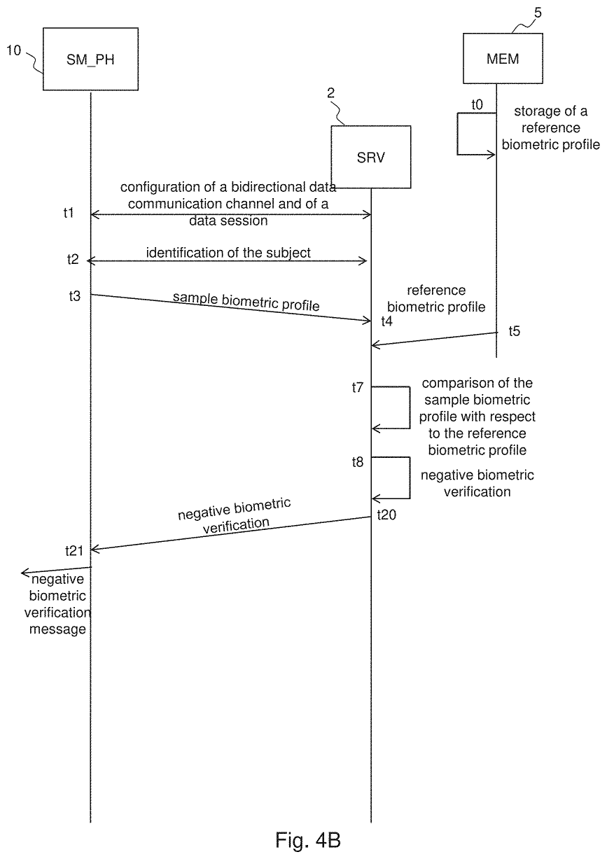

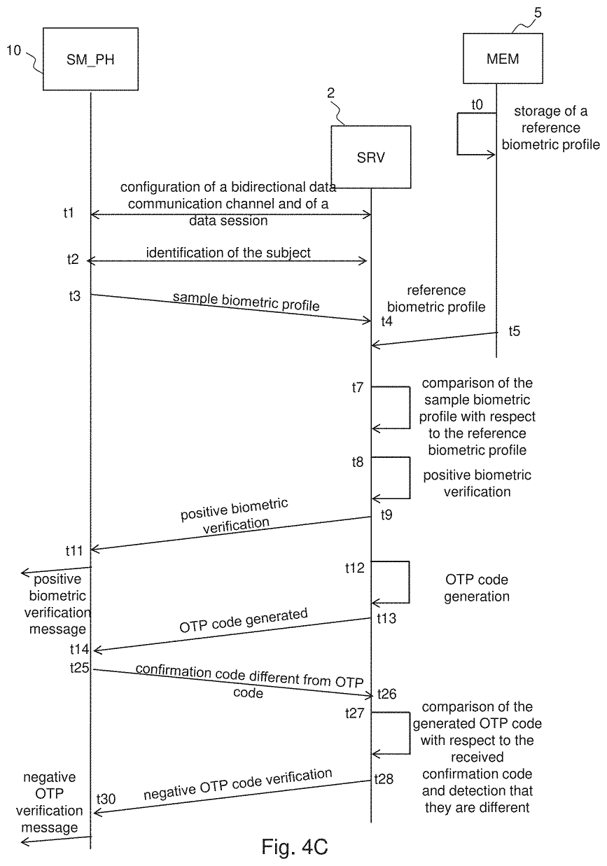

The network element 2 is for example a network server, i.e. an electronic device having the function of running (together with the user electronic device 10) a software application that allows interacting with the user electronic device 10, in order to perform a online procedure for the identification and authentication of the subject 7, by means of an architecture of the client-server type, as will be explained in more detail in the following with reference to the description of FIGS. 3A-3C and 4A-4C.

The user electronic device 10 is bidirectionally connected to the network element 2 by means of a data communication channel crossing the telecommunications network 4.

The telecommunications network 4 can be of the fixed type (for example, Internet), mobile or a combination of fixed and mobile.

The electronic system 1 also comprises a non-volatile memory 5 (typically, a database) having the function of storing a reference biometric profile of the subject 7, such as for example:

one or more images representative of a portion of the body of the subject 7, in particular of his/her face or of the tip of one of his/her fingers;

a plurality of biometric parameters of the subject 7, in particular of his/her face or the tip of his/her finger;

a text file that contains an anonymous coded representation of biometric parameters of the subject 7.

The memory 5 can be inside the network element 2 or it can be external to it and electrically connected with the network element 2.

The term “identification procedure” means the set of steps performed by the user 7 (by means of the user electronic device 10) and by the network element 4 wherein the data of the user 7 are acquired online, such as for example the name and surname and one or more among the following other data: date of birth, home address, land-line phone number, mobile number, tax code.

The term “authentication procedure” means the set of steps performed by the user 7 (by means of the user electronic device 10) and by the network element 4 wherein an online verification of the identity of the user 10 is performed, i.e. it is verified whether the user 7 is actually he/she who has claimed to be in the previous identification procedure, as will be explained in more detail below.

The user electronic device 10 is controlled by the user 7 and is such to run a user software application that allows interacting with the network element 2 through the data communication channel in order to perform said identification and authentication procedure, as will be explained in more detail in the following with reference to the description of FIGS. 3A-3C and 4A-4C.

The user electronic device 10 can be of the mobile type, such as for example a laptop personal computer, a smartphone, a tablet.

Alternatively, the user electronic device 10 can be a desktop personal computer.

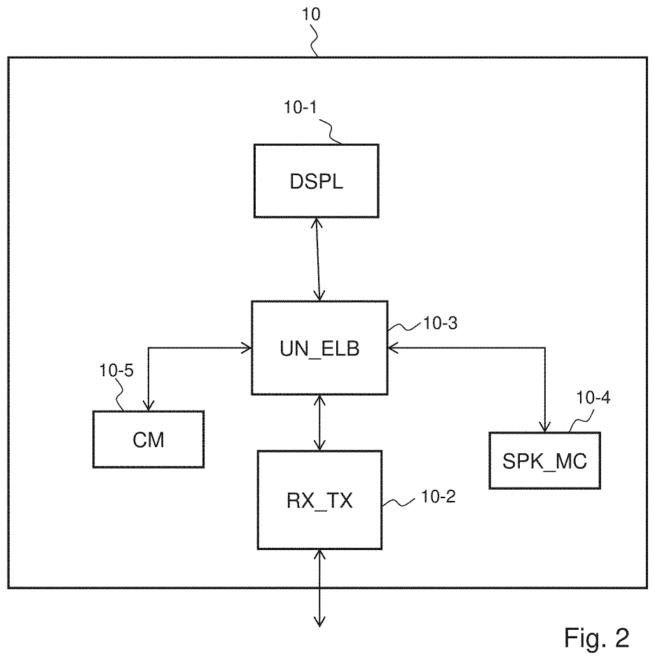

With reference to FIG. 2, it shows more in detail the user electronic device 10, which comprises:

a graphical user interface 10-1;

a transceiver 10-2;

a processing unit 10-3 (for example, a microprocessor);

a camera 10-5.

The transceiver 10-2 has the function of receiving/transmitting text messages, audio data and audio-video data from/towards the network element 2 and has the function of exchanging messages with the network element 2 in order to perform the identification and authentication procedure of the subject 7.

In particular, the transceiver 10-2 is configured to transmit towards the network element 2 data representative of a sample biometric profile associated with the subject 7 calculated in real time, as will be explained in more detail below.

The sample biometric profile can be for example:

one or more images acquired in real time representative of a portion of the body of the subject 7, in particular of his/her face or of the tip of one of his/her fingers;

a plurality of biometric parameters of the subject 7 calculated in real time, in particular of his/her face or the tip of his/her finger;

a text file generated in real time that contains an anonymous coded representation of biometric parameters of the subject 7.

Moreover, the transceiver 10-2 is configured to transmit towards the network element 2 a message carrying the value of a confirmation code that is a string of alphanumeric characters and its value can be equal or different with respect to the value of a generated random code valid only once for a defined time interval, as will be explained in more detail below.

The term “random code valid only once for a defined time interval” means a random code (typically an alphanumeric string containing numbers and/or letters) valid for a single access session or transaction for a short period of time (for example, 10 minutes), indicated with OTP (“One-Time Password” or “One-Time PIN”).

The random code valid only once for a defined time period (abbreviated hereinafter with “OTP Code”) can be generated near the user electronic device 10 by means of a token device: in this case the transceiver 10-2 is configured to transmit towards the network element 2 a message carrying the value of the confirmation code equal to the value of the locally generated OTP code.

Alternatively, the OTP code is generated in a remote position with respect to the user electronic device 10 (in particular, it is generated in the network element 2) and thus the transceiver 10-2 is configured to receive from the telecommunications network 4 a message carrying the value of the remotely generated OTP code.

In the case of remote generation of the OTP code, the transceiver 10-2 is configured to receive from the network element 2 a text message carrying the value of the remotely generated OTP code, and the transceiver 10-2 is further configured to transmit towards the network element 2 a message carrying the value of the confirmation code equal to the value of the received OTP code, in the case of correct reception of the OTP code by the user electronic device 10 and in the case of the correct typing by the user 7 of the value of the OTP code in an appropriate field of a screen displayed on the screen 10-1 of the user electronic device 10; otherwise, the transceiver 10-2 is configured to transmit towards the network element 2 a message carrying the value of the confirmation code different from the value of the received OTP Code, in the case where the user electronic device 10 fails to receive the OTP code or in the case where the user 7 incorrectly types the value of the received OTP code in the appropriate field.

The processing unit 10-3 (for example, one or more microprocessors) is electrically connected to the transceiver 10-2 and to the graphical user interface 10-1 and it has the following functions:

processing of the text messages, audio and audio-video data received from the transceiver 10-2;

performing a part of the identification and authentication procedure, in particular by calculating the sample biometric profile as a function of one or more images representative of at least one part of the body of the subject 7 (for example, his/her face);

suitably guiding a graphical user interface 10-1;

transmitting text messages, audio data and audio-video data to the transceiver 10-2.

The graphical user interface 10-1 allows the user 7 to interact with the user electronic device 10 by means of text commands and graphic objects.

The graphical user interface 10-1 is for example a screen of the LCD or LED touch type.

The graphical user interface 10-1 in turn comprises an area having the function of displaying text messages exchanged between the network element 2 and the user electronic device 10 by means of short text messages (SMS), by means of a text chat or by means of email messages.

Therefore the first user electronic device 10 communicates in real time with the operator electronic device by means of short text messages, or by means of the text chat or by means of email messages.

The camera 10-5 has the function of acquiring one or more images in real time of at least one portion of the body of the subject 7 that uses the user electronic device 10.

For example, in the case wherein the user electronic device 10 is a smartphone, the camera 10-5 is the front camera of the smartphone (i.e. the one positioned on the same side in which the screen 10-1 of the smartphone 10 is positioned) and is such to capture real-time images representative of the face of the subject 10.

In the case wherein the user electronic device 10 is a portable personal computer, the camera 10-5 is the integrated camera positioned above the longer side at the top of the screen and is configured to capture real-time images representative of the face of the subject 10.

In the case wherein the user electronic device 10 is a desktop personal computer, the camera 10-5 is a webcam hooked above the upper end of the screen and is configured to capture real-time images representative of the face of the subject 10.

The network element 2 comprises a signals transceiver and a processing unit (for example, a microprocessor).

The processing unit of the network element 2 has the function of performing a biometric recognition of the subject 7, by means of the comparison between the sample biometric profile of the subject 7 calculated in real time and the previously stored reference biometric profile of the subject 7.

Furthermore, the processing unit of the network element 2 has the function of performing an OTP code verification.

The transceiver of the network element 2 is configured to receive a message carrying data representative of the sample biometric profile of the subject 7, it is configured to transmit a message indicating a positive or negative verification of the biometric recognition of the subject 7, and it is configured to transmit a message indicating a positive or negative verification of an OTP code.

Also in case wherein the OTP code is generated in the network element 2, the transceiver of the network element 2 is configured to transmit towards the user electronic device a message carrying the value of the generated OTP code.

With reference to FIG. 4A, it shows the time diagram of the online identification and authentication method of a subject 7 according to the disclosure, in the case of a positive verification of the identity of the subject 7.

At the instant t0 the reference biometric profile of the subject 7 is stored into the memory 5.

At the instant t1 (following t0), it is performed the configuration of a bidirectional data communication channel between the user electronic device 10 (for example, a smartphone) and the network element 2.

A data session is also established between the user electronic device 10 and the network element 2.

At instant t2 (following t1) the identification of the subject 7 is performed.

In particular, at the instant t2 the data of the user 7 are acquired online (i.e. in real time), such as for example name and surname and one or more of the following data: date of birth, home address, land-line phone number, mobile number, tax code.

At instant t3 the camera 10-5 of the user electronic device 10 acquires one or more images representative of one portion of the body of the subject 7 (for example, his/her face), then the processing unit 10-3 generates, as a function of said images, the sample biometric profile associated with the subject 7.

Subsequently, the user electronic device 10 transmits towards the network element 4 data representative of the sample biometric profile of the subject 7.

At instant t4 the network element 4 receives said data representative of the sample biometric profile of the subject 7, then it reads from the memory 5 data representative of the reference biometric profile of the subject 7.

At instant t7 the processing unit of the network element 2 performs the comparison between the sample biometric profile and the reference biometric profile of the subject 7, in order to verify if they are equal, i.e. to verify whether the subject 7 (that is using the user electronic device 10) is actually the subject he/she has claimed himself/herself to be.

At instant t8 the processing unit of the network element 2 detects that the sample biometric profile and the reference biometric profile are equal and thus the outcome of the biometric verification of the subject 7 is positive.

At instant t9 the network element 2 transmits towards the user electronic device 10 a message indicating the positive verification of the biometric recognition of the subject 7.

At instant t11 the user electronic device 10 receives said message indicating the positive verification of the biometric recognition and, in particular, it generates therefrom (on a screen 10-1 of the user electronic device 10) a textual and/or graphic message representing a positive biometric verification of the subject 7.

At instant t11 the check of the first factor of the strong authentication procedure according to the disclosure terminates, i.e. the one which uses the biometric recognition and at the instant t12 the check of the second factor of the strong authentication procedure according to the disclosure begins.

For the purposes of explanation of the disclosure it is assumed that at the instant t12 the processing unit of the network element 2 generates a random code valid only once (i.e. for a single access session or transaction) for a defined time period (for example, 10 minutes), indicated with OTP (“One-Time Password”, or “One-Time PIN”), or an alphanumeric string containing numbers and/or letters.

Subsequently, at instant t13 the network element 4 transmits towards the user electronic device 10 a text message (for example, a short text message) carrying the value of the generated OTP code.

At instant t14 the user electronic device 10 receives the message carrying the value of the generated OTP code, which is displayed on the screen 10-1 of the user electronic device 10.

Subsequently, the subject 7 correctly enters the OTP code received in a field that is displayed on the screen 10-1 of the user electronic device 10, without making any errors of typing of the alphanumeric characters.

At instant t15 (following t14) the user electronic device 10 transmits to the network element 2 a message carrying the value of a confirmation code equal to the value of the OTP code received (i.e. the one entered in the appropriate field), then at instant t16 the network element 2 receives the confirmation code equal to the value of the OTP code generated by the network element 2.

At instant t17 the processing unit of the network element 2 performs the comparison between the generated OTP code and the received confirmation code and it detects that they are equal.

At instant t18 the network element 2 transmits towards the user electronic device 10 a message indicating the positive verification of the OTP code.

At instant t19 the user electronic device 10 receives said message indicating the positive verification of the OTP code and it generates therefrom (on a screen 10-1 of the user electronic device 10) a textual and/or graphic message representative of the positive verification of the OTP code.

Therefore at instant t19 the identity of the subject 7 was successfully verified online and thus the access of the subject 7 to the requested service is enabled, such as for example access to a bank account of the subject 7.

With reference to FIG. 4B, it shows the time diagram of the online identification and authentication method of a subject 7 according to the disclosure, in the case of a negative verification of the identity of the subject 7.

The time diagram of FIG. 4B is equal to that of FIG. 4A up to the instant t8 wherein the processing unit of the network element 2 detects that the sample biometric profile and the reference biometric profile are different and thus the outcome of the biometric verification of the subject 7 is negative.

In this case at instant t20 the network element 2 transmits towards the user electronic device 10 a message indicating the negative verification of the biometric recognition of the subject 7.

At instant t21 the user electronic device 10 receives said message indicating the negative verification of the biometric recognition and generates therefrom (on the screen 10-1 of the user electronic device 10) a textual and/or graphic message representative of the negative biometric verification of the subject 7, thus the online verification of the identity of the subject 7 was not successful and the access of the subject 7 to the requested service is disabled.

Therefore in the case of negative biometric verification, an OTP code is not even generated in the network element 2.

With reference to FIG. 4C, it shows the time diagram of the online identification and authentication method of a subject 7 according to the disclosure, in the case of a negative verification of the identity of the subject 7.

The time diagram of FIG. 4C is equal to that of FIG. 4A up to the instant t15.

At instant t14 the user electronic device 10 receives the message carrying the value of the generated OTP code, which is displayed on the screen 10-1 of the user electronic device 10.

Subsequently, the subject 7 makes at least one error of typing the alphanumeric characters of the received OTP code while entering it in the field displayed on the screen 10-1 of the user electronic device 10, thus entering in said field a string of alphanumeric characters which is different from the string of alphanumeric characters in the received OTP code.

At instant t25 (following t14) the user electronic device 10 transmits towards the network element 2 a message carrying the value of a confirmation code equal to the value entered by the subject 7 in the suitable field (and thus different from the value of the received OTP code), then at instant t26 the network element 2 receives the confirmation code which is different from the value of the OTP code generated by the network element 2.

At instant t27 the processing unit of the network element 2 performs the comparison between the generated OTP code and the received code and detects that they are different.

At instant t28 the network element 2 transmits towards the user electronic device 10 a message indicating the negative verification of the OTP code.

At instant t29 the user electronic device 10 receives said message indicating the negative verification of the OTP code and generates therefrom (on the screen 10-1 of the user electronic device 10) a textual and/or graphic message representative of the negative verification of the OTP code, thus the online verification of the identity of the subject 7 was not successful and the access of the subject 7 to the requested service is disabled.

With reference to FIGS. 3A-3C, they show the flow chart 100 of the online identification and authentication method of a user 7 according to the disclosure.

The flow chart 100 is partly performed on the user electronic device 10 and partly on the network element 2.

In addition the flow chart 100 is at least partly carried out by means of a software program running on the processing unit 10-3 of the user electronic device 10 and is at least partly carried out by means of a software program running on the processing unit of the network element 2.

In particular, the software program running on the processing unit 10-3 of the user electronic device 10 performs at least the steps 105, 106, 107, 109, 110, 112, 113.

The software program running on the processing unit of the network element 2 performs at least the steps 104, 105, 106, 108, 109, 110, 111, 114, 115, 116.

The flow chart 100 comprises an initial configuration phase and a subsequent phase of normal operation, wherein:

the configuration phase comprises the steps 102, 103, 104;

the normal operation phase comprises the remaining steps 105 . . . 116.

The configuration phase is carried out in a secure condition for the identity of the subject, such as for example:

when the subject installs a software application for the first time on his/her user electronic device 10 of the mobile type, which will be used thereafter in order to access a service by means of a session that requires the online verification of the identity of the subject himself/herself;

when the subject opens a bank account with a bank and is identified in person by an employee of the bank.

In the normal operation phase the subject 7 uses his/her user electronic device 10 to access a service by means of a session that requires the online verification of the identity of the subject himself/herself.

The flow chart 100 starts with step 101.

Step 101 is followed by step 102 wherein the registration of a subject 7 for the use of a service is carried out.

For example, the registration of the subject can be the first installation of a software application on his/her user electronic device 10 of a mobile type as illustrated above, or it can be the opening of a bank account as shown above.

Step 102 is followed by step 103 wherein one or more images are acquired which are representative of at least one portion of the body of the subject 7.

The images can be acquired in real time by a camera which frames the subject 7, such as for example the front camera of the smartphone 10.

Alternatively, in step 103 the images are acquired by scanning a photograph of an identity document of the subject 7.

The portion of the body of the subject 7 can be for example his/her face or the tip of one of his/her fingers.

Furthermore in step 103 it is generated a reference biometric profile associated with the subject 7, as a function of the images acquired in real time.

The reference biometric profile is of the ideal type, i.e. it is considered reliable and it will be used later for comparison with a sample biometric profile acquired in real time which is not necessarily reliable, as it will be explained in more detail below.

In one embodiment, the reference biometric profile is generated by means of the acquisition of a plurality of biometric parameters of the face of the subject 7 obtained by means of the movement of the head of the subject 7, as described in the Italian patent application no. 102017000145528 filed on 18 Dec. 2017 in the name of the same Applicant, which is included by reference in the present description.

Step 103 is followed by step 104 wherein the reference biometric profile associated with the subject 7 is stored into a database 5.

For example, the reference biometric profile is stored into a database 5 connected with the network element 2 that is a network server.

The configuration phase terminates with step 104.

Step 104 is followed by step 105, wherein the normal operation phase begins.

In step 105 the configuration of a bidirectional data communication channel is carried out between the user electronic device 10 and the network element 2.

Furthermore, in step 105 a bidirectional data session is established with a user electronic device 10 of the subject 7.

A first example is that of a data session established between the user electronic device 10 and the network element 5, by means of a chat bot running on the network element 5.

A second example is that of a data session established between the user electronic device 10 and the operator electronic device, through the network element 2, by means of an operator 6 connected to the operator electronic device.

Therefore the subject 7 receives from the network 4 and transmits to the network 4 data of the text message and/or audio message and/or video stream type, by means of said data session.

Step 105 is followed by step 106, wherein the subject 7 of the user electronic device 10 is identified online.

In particular, in step 106 the data of the user 7 are acquired online (i.e. in real time), such as for example name and surname and one or more of the following data: date of birth, home address, land-line phone number, mobile number, tax code.

Step 106 is followed by 107 wherein one or more images are acquired in real time, by the user electronic device 10, which are representative of at least one portion of the body of the subject 7.

The portion of the body of the subject 7 can be for example the face or the tip of one finger.

Furthermore, in step 107 a sample biometric profile associated with the subject 7 is generated, as a function of the acquired images; the sample biometric profile is then generated in real time during the data session established with the user electronic device 10.

In one embodiment, the sample biometric profile is generated by means of the acquisition of a plurality of biometric parameters of the face of the subject 7 obtained by means of the movement of the head of the subject 7, as described in the Italian patent application no. 102017000145528 filed on 18 Dec. 2017 in the name of the same Applicant, wherein it is disclosed that said movement of the head of the subject 7 comprises one or more among the following movements:

rotation of the head towards the right starting from an initial position (for example the front with respect to the camera 10-5);

rotation of the head towards the left starting from an initial position (for example the front with respect to the camera 10-5);

rotation of the head towards the right starting from an initial position (for example the front with respect to the camera 10-5) and subsequently the rotation of the head towards the left starting from an initial position (for example the front with respect to the camera 10-5), or vice versa;

raising the head upwards;

lowering the head downwards;

raising the head upwards and then lowering the head downwards (or vice versa).

In the case of the rotation of the head of a subject 7 towards the right or left, the camera 10-5 is configured to acquire at least 10 images per second representative of the face of the subject 7 during the rotation movement starting from an initial position (for example, the front with respect to the camera) up to a final position (for example, with the side of the face with respect to the camera).

According to one embodiment of the disclosure, the subject 7 makes (in addition or as an alternative to the movement of the head) a change in the expression of the face in a substantially fixed position of the head and a continuity check is again carried out between successive images of the plurality of images of the face of the subject 7 acquired by the camera 2 while the subject changes the expression of the face: in this way the reliability of the recognition of a live face is further increased, because a random action is carried out that can only be performed by a living person.

For example, the change in the expression of the face can be a smile, an expression of surprise, an expression of anger, or a combination thereof.

In the case of a change in expression of the face of a subject 7, the camera 10-5 is configured to acquire at least 10 images per second representative of the face of the subject 7 during the change in expression of the face in a substantially fixed position (for example, a front position with respect to the camera 10-5).

Step 107 is followed by step 108 wherein a comparison is performed between the sample biometric profile (generated in the previous step 107 of the normal operation phase) and the reference biometric profile (generated in step 103 of the previous configuration phase):

in the case wherein the sample biometric profile is compatible with the reference biometric profile, step 108 is followed by step 110;

in the case wherein the sample biometric profile is not compatible with the reference biometric profile, step 108 is followed by step 109.

In particular, said biometric profile is transmitted by the user electronic device 10 towards the network element 4, which carries out said comparison between the sample biometric profile and the reference biometric profile, then the network element 4 transmits to the user electronic device 10 a message indicating the positive or negative outcome of said comparison.

The sample biometric profile is compatible with the reference biometric profile when the subject 7 who is trying to access an online service by means of the user electronic device 10 is the same person that previously registered for the use of the same service.

For example, the subject 7 is the holder of a bank account that was previously opened and subsequently wants to access his/her bank account via the Internet to perform a certain operation (for example, payment by bank transfer): in this case in step 108 a biometric recognition of the subject 7 is performed in order to verify that it is the same person.

According to one embodiment of the disclosure, in step 108 the processing unit of the network element 2 performs the step of verifying the presence of the live face by performing an acquisition of a plurality of images of the face of the subject 7 during the execution of the sequence of the following steps:

rotating the head of the subject 7 towards the right and acquiring an image at the end of the rotation movement of the head towards the right, then rotating the head of the subject 7 to the left and acquiring an image at the end of the rotation movement of the head towards the left (or vice versa, reversing right with left);

positioning the face oriented in front with respect to the camera, smiling, acquiring an image with a smile and then return to a neutral expression;

verifying the consistency between the profile image acquired at the end of the rotation to the right, the profile image acquired at the end of the rotation to the left and the frontal image acquired with a smile.

In one embodiment, the continuity check between successive images of the face of the subject 7 while he/she performs a rotation of the head towards the right or left is performed by analysing the change of one or more of the following values:

ratio between the distance of a particular point of the nose from a particular point of the contour of the face (for example, the right contour) and the distance of the same particular point of the nose from a particular point of the other contour of the face (for example, the left contour);

ratio between the distance of a particular point of the nose from a particular point of the contour of the face (for example, the right contour) and the distance of the same particular point of the nose of the same particular point of the other contour of the face (for example, the left contour);

ratio between the distance of a particular point of the nose from a particular point of the contour of the face (for example, the right contour) and the distance of another particular point of the nose from a particular point of the other contour of the face (for example, the left contour);

ratio between the distance of two or more particular points of the nose from two or more particular points of the contour of the face (for example, the right contour) and the distance of the same particular two or more points of the nose from two or more particular points of the other contour of the face (for example, the left contour);

ratio between the distance of two or more particular points of the nose from two or more particular points of the contour of the face (for example, the right contour) and the distance of two or more other particular points of the nose from two or more particular points of the other contour of the face (for example, the left contour);

Alternatively, it is possible to use the contour of the eyebrows instead of the contour of the face, thus the above considerations relating to the calculation of the ratio with the nose are applicable in a similar way by replacing the contour of the face with that of the eyebrows.

In one embodiment, the continuity check between successive images of the face of the subject 7 while he/she changes the expression of the mouth (for example, a smile) when turned to the front with respect to the camera is performed by analysing the change of the ratio between the width of the mouth and the distance between the eyes of the subject 7: this allows verifying if the subject 7 is indeed changing the expression of the mouth (in the example, smiling).

In step 109 a textual and/or graphic message is generated which is representative of a negative verification of the identity of the subject 7.

The negative verification message can be for example:

a sign in the colour red (for example, the letter ‘X’) displayed on the screen 10-1 of the smartphone 10;

a textual message of the type “access to service denied”.

In one embodiment, in step 109 an audio and/or video call is initiated towards a remote operator, in order to identify the cause of the negative biometric verification of the identity of the subject 7.

In step 110 a textual and/or graphic message is generated which is representative of a positive biometric verification of the subject 7.

In steps 109 and 110 the check of the first factor of the strong authentication procedure according to the disclosure terminates, i.e. the one that uses biometric recognition.

In step 111 the check of the second factor of the strong authentication procedure according to the disclosure begins, i.e. the one that uses a random code valid only once.

In particular, in step 111 an OTP code is generated, i.e. a random code valid only once for a defined time period.

In one embodiment, the OTP code is generated in the network element 2 and is sent as a text message to the user electronic device 10 of a mobile type, in particular a smartphone.

Step 111 is followed by step 112, wherein the user electronic device 10 receives the OTP code and a textual and/or graphic message is displayed on a screen 10-1 of the user electronic device 10 representative of the value of the received OTP code.

Step 112 is followed by step 113, wherein the subject 7 enters the received OTP code in a field displayed on the screen 10-1 of the user electronic device 10.

It should be noted that the subject 7 can correctly enter the value of the OTP code received in the appropriate field, or it is also possible that one or more errors can be made when typing the alphanumeric characters.

Alternatively, in the case wherein the user electronic device 10 is of the mobile type (e.g. a smartphone), in step 113 the subject 7 shows the screen 10-1 displaying the message of the received OTP code to a webcam of a personal computer.

Step 113 is followed by step 114, wherein the network element 2 receives a confirmation message carrying a confirmation code equal to the entered code.

Step 114 is followed by step 115, wherein it is checked if the received confirmation code is equal to the generated OTP code:

in the affirmative case (i.e. the subject 7 has entered correctly the value of the OTP code received in the appropriate field displayed on the screen 10-1), step 115 is followed by step 116;

in the negative case (i.e. the subject 7 has made a mistake while entering the value of the OTP code received in the appropriate field displayed on the screen 10-1), step 115 leads to step 109 shown previously.

In one embodiment, in step 109 an audio and/or video call is initiated towards a remote operator, in order to identify the cause of the negative OTP verification of the identity of the subject 7.

In step 116 a textual and/or graphic message is generated which is representative of a positive verification of the identity of the user.

The positive verification message can be for example:

a sign in the colour green (for example, the symbol √) displayed on the screen 10-1 of the smartphone 10;

a textual message of the type “access to service enabled”.

Therefore in step 116 the check of the second factor of the strong authentication procedure according to the disclosure terminates with a positive outcome, i.e. the one that uses the OTP code.

Step 116 is followed by step 117 wherein an image representative of at least one portion of the face of the subject 7 is acquired in real time.

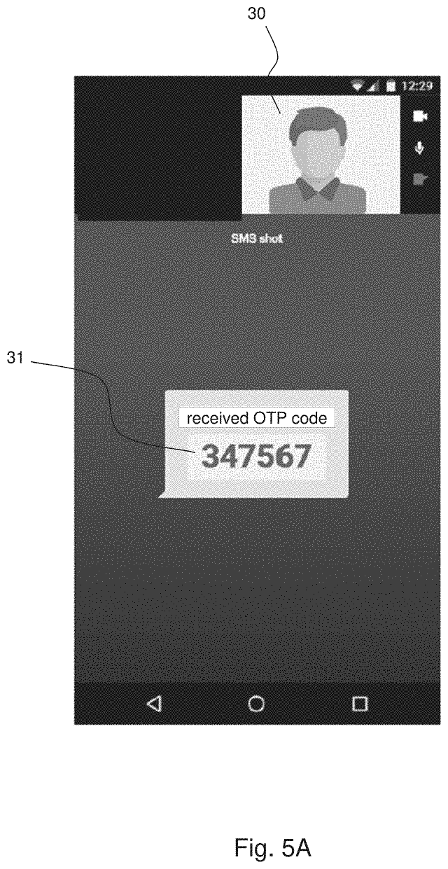

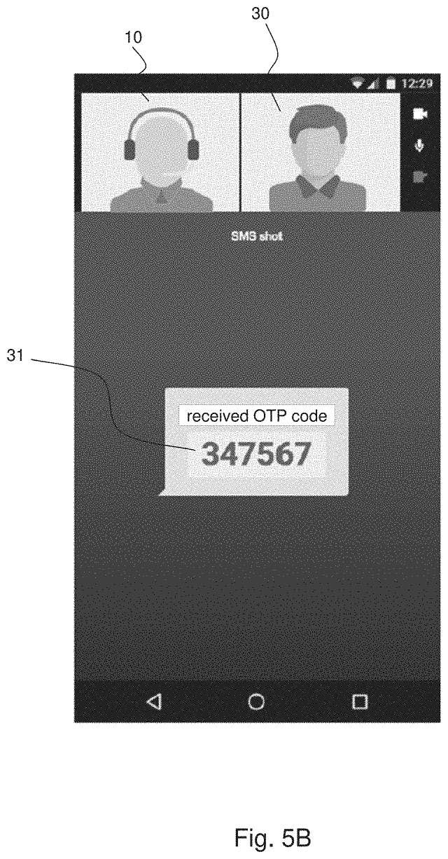

Step 117 is followed by step 118, wherein a single proof image is stored comprising the image of at least one portion of the face of the subject acquired in real time (see the portion 30 of the screen 10-1 of FIGS. 5A-5B) and at the same time comprising a textual and/or graphic representation of the received OTP code (see the portion 31 of the screen 10-1 of FIGS. 5A-5B).

Step 118 is followed by step 131, wherein the flow chart 100 ends.

According to a variant of the disclosure, after the user electronic device 10 receives the message indicating the positive verification of the OTP code (instant t19), the camera 10-5 of the user electronic device 10 acquires an image 30 (see FIGS. 5A-5B) in real time representative of at least one portion of the face of the subject 7, then the transceiver 10-2 of the user electronic device 10 transmits a message to the network element 2 carrying a proof image that is a single image comprising the image 30 representative of at least one portion of the face of the subject 7 (and possibly of a remote operator 10) and further comprising a textual representation of the random code received and validated 31.

Moreover, the transceiver of the network element 2 receives the proof image and this is stored into the memory 5.

The storage of the proof image that simultaneously contains the face in real time of the subject 7 (and possibly of the remote operator 10) and the textual representation of the OTP code received and validated has the advantage of further improving the security level of the identification of the subject 7, because it is representative of the simultaneity of the two authentication factors, in particular biometric recognition and OTP code, or vice versa.

It should be noted that in the time diagrams of FIG. 4A-4C and in the flow chart 100 of the identification and authentication method of FIG. 3A-3C, it is considered the case wherein the OTP code is generated in a remote position with respect to the user electronic device 10 (i.e. the OTP code is generated in the network element 2) and then it is transmitted to the user electronic device 10 (for example, by means of a text message). Other solutions are also possible such as the local generation of the OTP code by means of token devices: in this case steps 112 and 113 are not present and step 111 is directly followed by step 114 wherein the user electronic device transmits to the telecommunication network 4 the confirmation message carrying the locally generated OTP code, and furthermore in step 117 at least one proof image is stored comprising the at least one image of the portion of the subject's face acquired in real time and at the same time comprising the textual and/or graphic message of the locally generated OTP code.

It should also be noted that in the time diagrams of FIG. 4A-4C and in the flow chart 100 of the identification and authentication method of FIG. 3A-3C the case is considered wherein first the biometric recognition of the subject is performed and then (in the case of a positive verification of the biometric profile) the OTP Code is generated; alternatively, it is possible to first generate the OTP code and then (in the case of a positive verification of the OTP code) it is performed the biometric recognition of the subject.

It should also be noted that the second authentication factor used is the OTP code in the flow chart 100 of the identification and authentication method, but alternatively also another authentication factor can be used, such as an email message that is sent to an mailbox of the user 7 and it is read by the user electronic device 10: in this case the email message contains a link and the user 7 is asked to open said link by means of a browser, then the network element 2 receives a message indicating the opening of said link by the user 7.

More generally, the second authentication factor (alternative to the OTP code) can be a generic action of random verification asked of the user 7.

In one embodiment, in step 108 the biometric recognition of the subject 7 is carried out using a reference biometric profile of the face and a sample biometric profile of the face defined by means of a plurality of biometric parameters of at least one portion of the face of the subject calculated by means of a movement of the head of the subject as described in the Italian patent application no. 102017000145528 filed on 18 Dec. 2017 in the name of the same Applicant, which is considered included by reference within the present description.

In particular, it is generated in advance the reference profile defined by means of a plurality of biometric parameters of at least one portion of the face of the subject, it is generated in real time the sample profile defined by means of a plurality of biometric parameters of at least one portion of the face of the subject, then one or more of the following comparisons are carried out:

comparison of their compatibility in the changes of the values of the plurality of biometric parameters of the face of the sample profile;

comparison of compatibility between the values of the plurality of biometric parameters of the face of the reference profile and the values of the plurality of biometric parameters of the face of the sample profile.

In particular, in step 108 it is carried out (by means of the processing unit of the network element 2) an image processing which performs a check of the continuity of one or more biometric parameters among successive images of a plurality of the images acquired by the camera 10-5 of the face and/or head of the subject 7 while the subject 7 performs one or more movements of the head and/or one or more changes in the expression of the face: in this way it is possible to recognise in real time, with high reliability, if the acquired images are representative of at least part of the face of a living person, or if they are images representative of at least part of a face of a person who is not living, such as static images that were previously taken which are representative of the face of the same person or a video of the face of a person who has been previously recorded, or if they are representative images of a paper reproduction in actual size of the face of a person.

The term “continuity check” means that a plurality of measurements of one or more biometric parameters of the face of the considered person as performed on a respective plurality of images acquired at successive instants (during a movement of the head and/or a change in the expression of the face) are mutually compatible.

It should be noted that said continuity check is based on the fact that the measurements (for example, ratios) of certain biometric parameters of the face increase or decrease during the movement of the head of the person in a three-dimensional perspective.

In one embodiment, the movement of the head of the subject 7 comprises a rotation of the head towards the right and thereafter a rotation of the head towards the left, or vice versa.

In one embodiment, the processing unit of the network element 2 is further configured to continuously verify the presence of a face of a person within an analysis area during the processing of the images for recognition of the live face, thus the screen 10-1 of the smartphone 10 is configured to display a textual and/or graphic indication of the correct positioning of the face inside the analysis area.

In one embodiment, the processing unit of the network element 2 is further configured to continuously verify the presence of the face of only one person within the analysis area during the processing of the images for recognition of the live face, thus the screen 10-1 of the smartphone 10 is configured to display a textual and/or graphic indication of the detection of more than one face within the analysis area.

In one embodiment, in step 108 the biometric recognition of the subject 7 is carried out by using the reference biometric profile and the sample biometric profile, further taking into account a further plurality of images representative of the face of a person, during a change in the expression of the face of the person (for example, a smile) in a particular position of the head which is substantially fixed; in this case the further plurality of images acquired is processed and, as a function thereof, at least a further biometric parameter of the face of the person associated with said change in expression is measured, obtaining a further plurality of measurements of the biometric parameter of the face, and finally it is verified whether the changes of the values of the additional plurality of measurements of the further biometric parameter associated with the change in expression are mutually compatible.

1-15. (canceled)

16. An electronic system for online verification of an identity of a subject, the electronic system comprising:
a user electronic device,
a network element and
a non-volatile memory, wherein the memory is configured to store data representative of a reference biometric profile of the face of the subject, wherein the user electronic device comprises:
a camera configured to acquire in real time at least one image representative of at least one portion of the face of a subject;
a processing unit configured to:
generate a sample biometric profile of the face of the subject, as a function of the at least one image acquired in real time that is representative of at least one portion of the face of the subject;
a transceiver configured to:
transmit data representative of the sample biometric profile of the face of the subject;
receive a message indicating a positive or negative verification of a recognition of the live face of the subject;
transmit a message carrying a value of a confirmation code equal to a random access code that is valid only once for a defined time interval;
receive a message indicating a positive or negative verification of the identity of the subject;
and wherein the network element comprises:
a transceiver configured to:
receive a message carrying data representative of the sample biometric profile of the face of the subject;
transmit said message indicating the positive or negative verification of the recognition of the live face of the subject;
transmit said message indicating the positive or negative verification of the identity of the subject; and
a processing unit configured to:
read from the memory data representative of the reference biometric profile of the face of the subject;
compare the sample biometric profile of the face of the subject with respect to the reference biometric profile of the face of the subject and verify whether the sample biometric profile of the face of the subject is compatible with the reference biometric profile of the face of the subject;
in case of a negative verification, generate said message indicating the negative verification of the recognition of the live face of the subject;
in case of a positive verification, compare the value of said generated random access code that is valid only once for a defined time interval with respect to the value of the confirmation code;
generate, as a function of said comparison, a message indicating a positive or negative verification of the random access code.

17. The electronic system according to claim 16, wherein the reference biometric profile of the face of the subject comprises a plurality of biometric parameters of the portion of the face of the subject, and wherein the camera is configured to real-time acquire a plurality of images representative of at least part of the face of the subject, during a movement of the head of the subject starting from an initial position,
and wherein the processing unit of the network element is further configured to:
receive the plurality of acquired images;
process the plurality of acquired images and measure, as a function thereof, at least one biometric parameter of the face of the subject associated with said movement of the head, obtaining a plurality of measurements of the biometric parameter of the face;
verify whether the values of the plurality of biometric parameters of the reference biometric profile of the face of the subject are compatible with the plurality of values of the measured biometric parameters of the sample biometric profile of the face of the subject;
generate said message indicating the positive or negative verification of the recognition of the live face, in case of said positive or negative verification, respectively, of the compatibility between the values of the plurality of the biometric parameters of the reference biometric profile of the face of the subject and the values of the plurality of the biometric parameters of the sample biometric profile of the face of the subject.

18. The electronic system according to claim 17, wherein the processing unit of the network element is further configured to:
verify whether the changes of values of at least a part of said plurality of measurements of the biometric parameter of the face associated with the movement of the head are compatible with each other;
generate said message indicating the positive or negative verification of the recognition of the live face, in case of said positive or negative verification, respectively, of the compatibility of the measurements of the biometric parameter.

19. The electronic system according to claim 17, wherein said movement of the head of the subject comprises a rotation of the head towards the right and subsequently a rotation of the head towards the left, or vice versa;
wherein the processing unit is further configured to verify said compatibility of the changes of values of at least part of said plurality of measurements during the rotation movement of the head towards the right or towards the left by means of the verification that a ratio between the distance of a particular point of the nose from a particular point of the contour of the face and the distance of the same particular point of the nose from the same particular point of another contour of the face increases or decreases among subsequently-processed images,
and wherein the processing unit is further configured to verify said compatibility of the change of the values of at least part of said further plurality of measurements during a smile by means of the verification that a further ratio between the width of the mouth and the distance between the eyes of the subject increases or decreases among subsequently-processed images.

20. The electronic system according to claim 17,
wherein the camera is further configured to acquire in real time a further plurality of images representative of the face of the subject, during a change in expression of the face of the subject in a particular position of the head substantially fixed, said change in expression of the face comprising a smile,
and wherein the processing unit is further configured to:
receive the further plurality of acquired images;
acquire, in real time, a further plurality of images representative of the face of the subject, during the change in expression of the face;
process the further plurality of acquired images and measure, as a function thereof, at least one further biometric parameter of the face of the subject associated with said change in expression, obtaining a further plurality of measurements of the biometric parameter of the face;
verify whether the changes of values of at least a part of said further plurality of measurements of the further biometric parameter associated with the change in expression are compatible with each other;
generate said message indicating the positive verification of the recognition of the live face, in a case of said positive verification of the compatibility of the measurements of the biometric parameter and the further biometric parameter; or
generate said message indicating the negative verification of the recognition of the live face, in a case of said negative verification of the compatibility of the measurements of the biometric parameter and the further biometric parameter.

21. The electronic system according to claim 16, wherein the processing unit of the network element is further configured to generate said generated random access code that is valid only once,
wherein the transceiver of the network element is further configured to transmit a short text message carrying the value of the generated random access code,
wherein the transceiver of the user electronic device is further configured to receive the text message carrying the value of the generated random access code.

22. The electronic system according to claim 16, wherein the camera of the user electronic device is further configured to acquire an image representative of at least one portion of the face in real time of the subject,
wherein the transceiver of the user electronic device is further configured to transmit to the network element a message carrying a single proof image comprising said image that is representative of the at least one portion of the face of the subject and further comprising a textual representation of the received and validated random access code,
wherein the transceiver of the network element is further configured to receive the proof image and the memory is configured to store the proof image.

23. The electronic system according to claim 22, wherein the user electronic device is of a mobile type and it comprises a display configured to display a single screenshot comprising the acquired image of the at least one portion of the face in real time of the subject and at the same time it comprises a graphical and/or textual representation of the received random access code, the electronic device further comprising a screen configured to display a field in which to enter the value of the received random access code.

24. The electronic system according to claim 16, wherein the network element is a network server and wherein the user electronic device is selected from a smartphone, a tablet or a desktop or laptop personal computer.

25. A method for online verification of the identity of a subject, comprising the steps of:
a) providing a non-volatile memory;
b) storing a reference biometric profile of the face of the subject into the non-volatile memory;
c) providing a user electronic device and an element of a telecommunications network;
d) configuring a bidirectional data communication channel and a data session between the user electronic device and the network element;
e) identifying the subject;
f) acquiring in real time, by means of a camera of the user electronic device, at least one image representative of at least one portion of the face of the subject;
g) online generating, as a function of the at least one acquired image, a sample biometric profile of the face of the subject associated with the subject;
h) transmitting, from the user electronic device to the network element, data representative of the sample biometric profile of the face of the subject;
i) at the network element, receiving the data representative of the sample biometric profile of the face of the subject, reading from the memory the values of the reference biometric profile of the face of the subject and comparing the values of the sample biometric profile of the face of the subject with respect to the values of the reference biometric profile of the face of the subject;
j) if the values of the sample biometric profile are compatible with the values of the reference biometric profile, continuing with step i);
k) if the values of the sample biometric profile are incompatible with the values of the reference biometric profile, transmitting from the network element to the user electronic device a message indicating a negative verification of the biometric recognition of the face of the subject;
l) if the values of the sample biometric profile of the face of the subject are compatible with the values of the reference biometric profile of the face of the subject, transmitting from the network element to the user electronic device a message indicating a positive verification of the biometric facial recognition of the subject;
m) receiving at the user electronic device the positive biometric facial verification message;
n) generating a random access code valid only once for a defined time period;
o) receiving at the network element a message carrying a value of a confirmation code;
p) comparing, at the network element, the value of the generated random access code with respect to the value of the received confirmation code;
q) transmitting, from the network element to the user electronic device, a message indicating a positive or negative verification of the identity of the subject, as a function of the detection of the value of the generated random access code equal to or different from the value of the received confirmation code, respectively;
r) receiving at the user electronic device the message of positive or negative verification of the identity of the subject and generating a textual and/or graphic indication representative of the positive or negative verification of the identity of the subject.

26. The method according to claim 25,
wherein step n) comprises the sub-steps of:
n1) generating at the network element said random access code that is valid only once for a defined time period;
n2) transmitting, from the network element to the user electronic device, a text message carrying the value of the generated random access code;
n3) receiving the text message at the user electronic device;
n4) transmitting, from the user electronic device to the network element, a message carrying a value of the confirmation code.

27. A non-transitory computer readable medium comprising a computer program adapted to perform the steps g), n) or the steps i), j), k), l), p) of the method according to claim 25, when said computer program is run on at least one computer.

28. A non-transitory computer readable medium comprising a computer program adapted to perform the steps g), n) or the steps i), j), k), l), p) of the method according to claim 26, when said computer program is run on at least one computer.

29. The electronic system according to claim 18,
wherein said movement of the head of the subject comprises a rotation of the head towards the right and subsequently a rotation of the head towards the left, or vice versa,
wherein the processing unit is further configured to verify said compatibility of the changes of values of at least part of said plurality of measurements during the rotation movement of the head towards the right or towards the left by means of the verification that a ratio between the distance of a particular point of the nose from a particular point of the contour of the face and the distance of the same particular point of the nose from the same particular point of another contour of the face increases or decreases among subsequently-processed images,
and wherein the processing unit is further configured to verify said compatibility of the change of the values of at least part of said further plurality of measurements during the smile by means of the verification that a further ratio between the width of the mouth and the distance between the eyes of the subject increases or decreases among subsequently-processed images.

30. The method according to claim 25,
wherein the step f) comprises acquiring in real time a plurality of images representing at least part of the face of the subject, during a movement of the head of the subject starting from an initial position,
and wherein step i) comprises the sub-steps of:
receiving the plurality of acquired images;
processing the plurality of acquired images and measuring, as a function thereof, at least one biometric parameter of the face of the subject associated with said movement of the head, obtaining a plurality of measurements of the biometric parameter of the face;
verifying whether the changes of the values of at least part of said plurality of measurements of the biometric parameter associated with the movement of the head are compatible with each other;
wherein step j) comprises a positive verification of the compatibility of the measurements of the biometric parameter,
and wherein step k) comprises a negative verification of the compatibility of the measurements of the biometric parameter.

31. The method according to claim 30, wherein step i) comprises verifying whether the values of the plurality of biometric parameters of the reference profile of the face of the subject are compatible with the plurality of values of the measured biometric parameters of the sample biometric profile of the face of the subject;
wherein step j) comprises a positive verification of the compatibility between the values of the plurality of biometric parameters of the reference profile of the face of the subject and the values of the plurality of biometric parameters of the sample profile of the face of the subject,
and wherein step k) comprises a negative verification of the compatibility between the values of the plurality of biometric parameters of the reference profile of the face of the subject and the values of the plurality of biometric parameters of the sample profile of the face of the subject.

32. The method according to claim 30,
wherein said movement of the head of the subject comprises a rotation of the head towards the right and subsequently a rotation of the head towards the left, or vice versa;
wherein step i) comprises verifying said compatibility of the changes of values of at least part of said plurality of measurements during the rotation movement of the head towards the right or towards the left by means of the verification that a ratio between the distance of a particular point of the nose from a particular point of the contour of the face and the distance of the same particular point of the nose from the same particular point of another contour of the face increases or decreases among subsequently-processed images,
and wherein step i) comprises verifying said compatibility of the change of the values of at least part of said further plurality of measurements during a smile by means of the verification that a further ratio between the width of the mouth and the distance between the eyes of the subject increases or decreases among subsequently-processed images.

33. The method according to claim 30,
wherein the step f) comprises acquiring in real time a further plurality of images representative of the face of the subject, during a change in expression of the face of the subject in a particular position of the head substantially fixed, said change in expression of the face comprising a smile,
and wherein step i) comprises the sub-steps of:
receiving the further plurality of acquired images;
acquiring, in real time, a further plurality of images representative of the face of the subject, during the change in expression of the face;
processing the further plurality of acquired images and measure, as a function thereof, at least one further biometric parameter of the face of the subject associated with said change in expression, obtaining a further plurality of measurements of the biometric parameter of the face;
verifying whether the changes of values of at least a part of said further plurality of measurements of the further biometric parameter associated with the change in expression are compatible with each other;
wherein step j) comprises a positive verification of the compatibility of the measurements of the biometric parameter and the further biometric parameter;
and wherein step k) comprises a negative verification of the compatibility of the measurements of the biometric parameter and the further biometric parameter.
